(19) United States
(12) Patent Application Publication
(10) Pub. No.: US 2011/0216646 A1
(43) Pub. Date: Sep. 8, 2011

(54) RESIDENTIAL GATEWAY FOR PROVIDING BACKUP INTERFACE TO EXTERNAL NETWORK

(75) Inventors: Chrtistofer Flinta, Stockholm (SE); Bob Melander, Sigtuna (SE)

(73) Assignee: TELEFONAKTIEBOLAGET LM ERICSSON (publ), Stockholm (SE)

(21) Appl. No.: 13/124,775

(22) PCT Filed: Oct. 16, 2008
(86) PCT No.: PCT/SE2008/051168

§ 371 Date: Apr. 18, 2011

(51) Int. Cl. H04W 24/00

(52) U.S. Cl. 370/220

(57) ABSTRACT

The invention relates to a residential gateway for providing an end user of a network terminal in a residential network with access to an external network, said residential gateway comprising at least one network terminal interface arranged to provide an internal connection to said network terminal and an external network interface arranged to provide a first external connection to said external network. The residential gateway is characterized in that it comprises a secondary external network interface arranged to establish a second external connection with a mobile radio communications network in order to provide a backup access path to said external network, and a control unit arranged to activate said secondary external network interface, if not already activated, in response to detecting a loss of network connectivity over said first external connection, and forward data traffic between said residential network and said external network through said activated secondary external network interface. The invention also relates to a method for use in a residential gateway and a computer programme product.

### TECHNICAL FIELD

The invention relates in general to a residential gateway, and in particular to a residential gateway according to the preamble of claim 1. The invention further relates to a method according to the preamble of claim 9 and a computer program product according to the preamble of claim 13.

### BACKGROUND

A residential gateway is a kind of network equipment found in most homes today. The residential gateway, also referred to as home gateway, is a hardware device connecting a home network to external networks, for example, a wide area network (WAN) such as the Internet.

A residential gateway may combine the functions of an IP router, multi-port Ethernet switch and WiFi access point. It may also provide port translation functionality (NAT), support for localized Quality of Service (QoS) enforcement and also serves as a dynamic DNS client, etc. The residential gateway may be arranged between the modem and the residential network, or an xDSL or cable modem may be integrated into the residential gateway.

The residential gateway normally has a connection, such as, an Ethernet connection or xDSL connection, which it uses to connect to the external networks, WANs or the Internet.

However, if the network connectivity over that connection or access path is lost, then the residential network becomes totally isolated. Such events are often seen as highly disturbing or even critical for end users relying on their internet access in order to, for example, connect to an internet bank in order to pay bills, perform transactions and/or checking account balances, etc.

### SUMMARY

A problem to which the invention relates is how to enable continuous access to an external network for a network terminal in a residential network.

This problem is addressed by a residential gateway for providing an end user of a network terminal in a residential network with access to an external network, said residential gateway comprising at least one network terminal interface arranged to provide an internal connection to said network terminal and an external network interface arranged to provide a first external connection to said external network, characterized in that said residential gateway comprises a secondary external network interface arranged to establish a second external connection with a mobile radio communications network in order to provide a backup access path to said external network; and a control unit arranged to activate said secondary external network interface, if not already activated, in response to detecting a loss of network connectivity over said first external connection, and forward data traffic between said residential network and said external network through said activated secondary external network interface.

The problem is further addressed by a method for use in a residential gateway in order to provide an end user of a network terminal in a residential network with access to an external network, said residential gateway comprising at least one network terminal interface arranged to provide an internal connection to said network terminal and an external network interface arranged to provide a first external connection to said external network, wherein the method is characterized by the steps of: detecting in said residential gateway as the network connectivity over said first external connection is lost; in response to said detection, activating a secondary external network interface in said residential gateway; establishing a second external connection between said activated secondary external network interface in said residential gateway and a mobile radio communications network in order to provide a backup access path to said external network; and forwarding data traffic between said residential network and said external network through said backup access path.

An advantage of the above described invention is that it provides a backup path for the residential gateway that can be used when connectivity is lost on the normal access path.

A further advantage of the above described invention is that is that it provides automatic switching to a backup connection upon the failure of the currently active connection so as to enable the residential gateway to provide continuous access to the external network.

Another advantage of the above described invention is that is that all network terminals located in the residential network can use the backup path without the need for any reconfigurations.

Preferably, the secondary external network interface according to the above may comprise a Bluetooth interface, Universal Serial Bus (USB) interface, WiFi interface, or some other access technology interface capable of providing a connection to a mobile terminal. By in this way exploiting the fact that most people have a mobile terminal at home through which a network connection can be obtained, allows for the residential gateway to relay data traffic via the mobile terminal, when detecting a loss of network connectivity through its normal access path, by using it as a modem.

If the mobile terminal is a 3G-compliant mobile terminal, the invention may be especially suitable since the 3G-compliant mobile terminal may still be used for taking/receiving telephone calls at the same time as it provides the backup access path for the residential gateway.

Alternatively, the secondary external network interface may comprise mobile communication means providing a wireless radio access path to a mobile radio communications network. This provides the residential gateway with the possibility to directly connect with a mobile radio communications network without having to use a readily available mobile terminal.

The problem is further addressed by a computer program product for use in a residential gateway for providing access for end users of network terminals in a residential network to an external network, which comprises computer readable code means, which when run in the residential gateway causes said residential gateway to perform the steps of: detecting as the network connectivity over a first external connection to said external network is lost; in response to said detection, activating a secondary external network interface in said residential gateway; establishing a second external connection between said activated secondary external network interface and a mobile radio communications network in order to provide a backup access path to said external network; and forwarding data traffic between said residential network and said external network through said backup access path.

Further advantageous embodiments of the residential gateway, the method and the computer programme product are set forth in the dependent claims, which correspondently describe further advantageous embodiments of the invention.

### BRIEF DESCRIPTION OF THE DRAWINGS

The invention will be described in more detail in the following with reference to the appended drawings, in which:

FIG. 1 shows a residential gateway connecting a residential network to an external network according to prior art.

FIG. 2 shows a residential gateway according to an exemplary embodiment of the invention connecting a residential network to an external network.

FIG. 3 shows a residential gateway according to an exemplary embodiment of the invention.

FIG. 4 shows a residential gateway according to another exemplary embodiment of the invention.

FIG. 5 shows a residential gateway according to the exemplary embodiment of the invention shown in FIG. 4 connecting a residential network to an external network.

FIG. 6 is a flowchart illustrating a method for providing a residential network with network access according to an exemplary embodiment of the invention.

FIG. 7 is a flowchart illustrating a method for providing a residential network with network access according to another exemplary embodiment of the invention.

### DETAILED DESCRIPTION

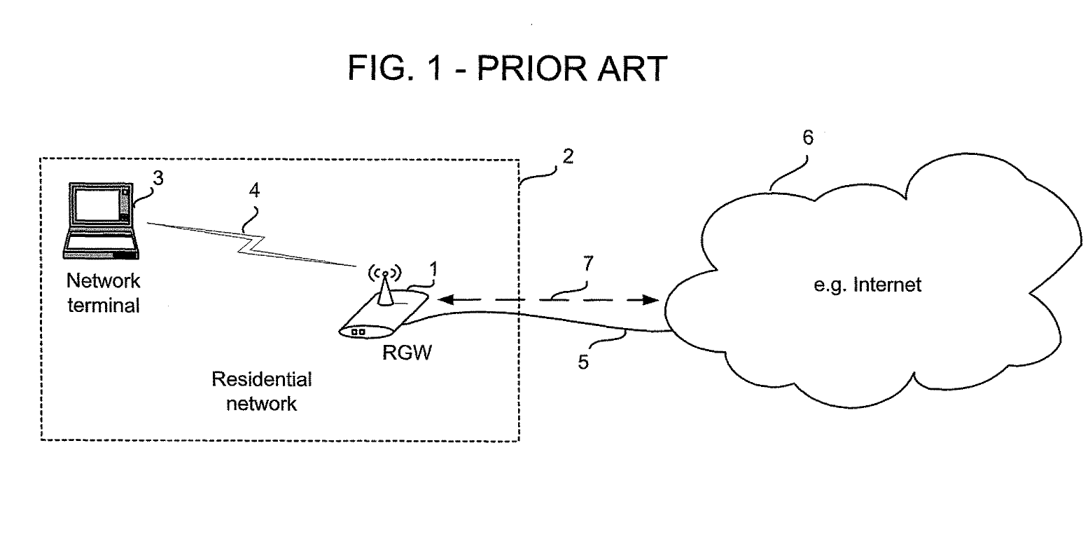

FIG. 1 shows a residential gateway (RGW) 1 connecting a residential network 2 to an external network 6 according to prior art. In FIG. 1, a residential gateway 1 is located in a residential network 2. The residential gateway 1 may comprise a xDSL or cable modem, or may be arranged between the residential network 2 and a modem (not shown). The modem provides a connection 5 for the residential gateway 1 to an external network 6, e.g. the Internet.

The residential network 2 may comprise at least one network terminal 3. The residential gateway 1 is arranged to communicate with the at least one network terminal 3 over a connection 4. The connection 4 may be a wireless connection (e.g. WiFi) or a physical connection (e.g. Ethernet cable). The residential gateway 1 may thus provide an access path 7 to the external network 6 for the at least one network terminal 3 in the residential network 2 over the connection 5.

However, if the network connectivity over the connection 5 providing the access path 7 to the external network 6 is lost, then the residential network 2 becomes totally isolated and the at least one network terminal 3 are unable to reach the external network 6.

This problem is addressed by the inventive features of the invention which by having a secondary external network interface in the residential gateway, enables the residential gateway to provide failover access to an external network by establishing a backup path through a mobile radio communications network.

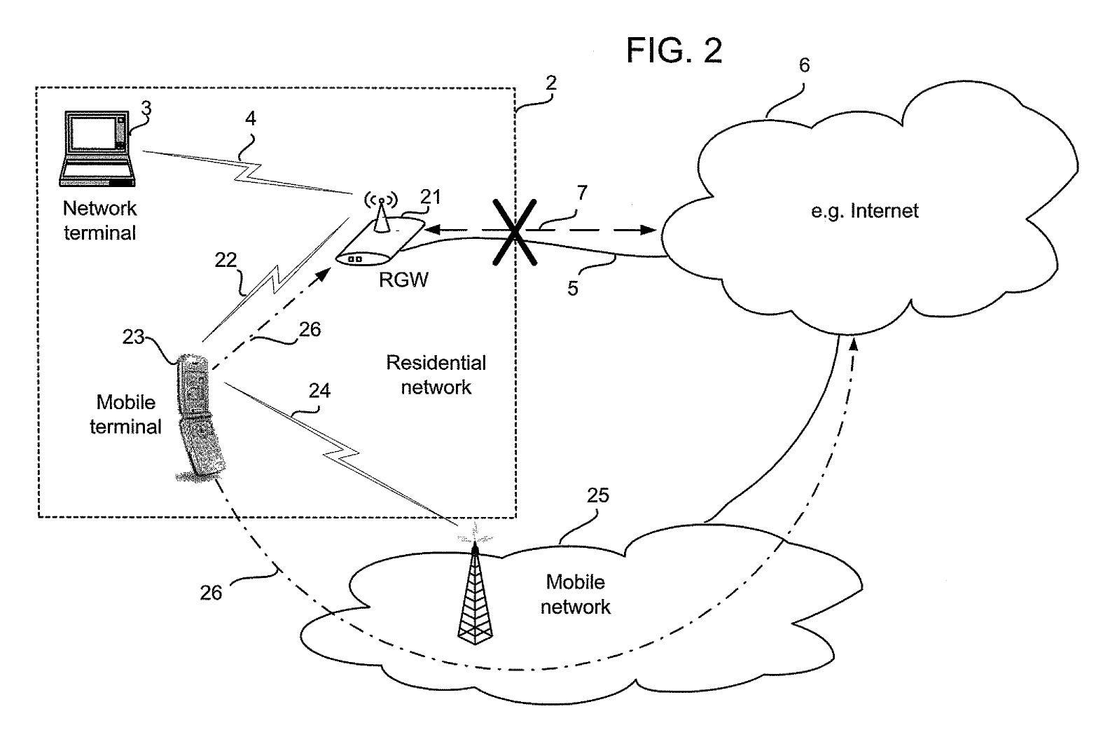

FIG. 2 shows a residential gateway (RGW) 21 according to an exemplary embodiment of the invention connecting a residential network 2 to an external network 6 by providing a backup access path 26 over a mobile radio communications network 25.

In FIG. 2, a residential gateway 21 is located in a residential network 2. The residential gateway 21 may comprise a xDSL or cable modem, or may be arranged between the residential network 2 and a modem (not shown). The modem provides a connection 5 for the residential gateway 21 to an external network 6, e.g. a WAN or the Internet. The residential network 2 may comprise at least one network terminal 3. The residential gateway 21 is arranged to communicate with the at least one network terminal 3 over a connection 4. The connection 4 may be a wireless connection (e.g. WiFi) or a physical connection (e.g. Ethernet cable). Thus, the residential gateway 21 may provide a normal access path 7 to the external network 6 for the network terminals 3 in the residential network 2 over the connection 5.

However, according to an illustrative example and as illustrated by the large “X” in FIG. 2, the network connectivity over the connection 5 providing the normal access path 7 to the external network 6 may, for example, be temporarily lost.

It is previously known to employ a mobile terminal as a data modem to form a wireless access point for connecting a network terminal directly to an external network without the need of a residential gateway. That is, the mobile terminal may serve as a gateway between mobile radio communications network and the network terminal, and thus provide access to the external network. However, this requires that the network terminal comprises specific mobile terminal configurations, and that the network terminal is directly connected to the mobile terminal. It may also only be used for a single network terminal at a time.

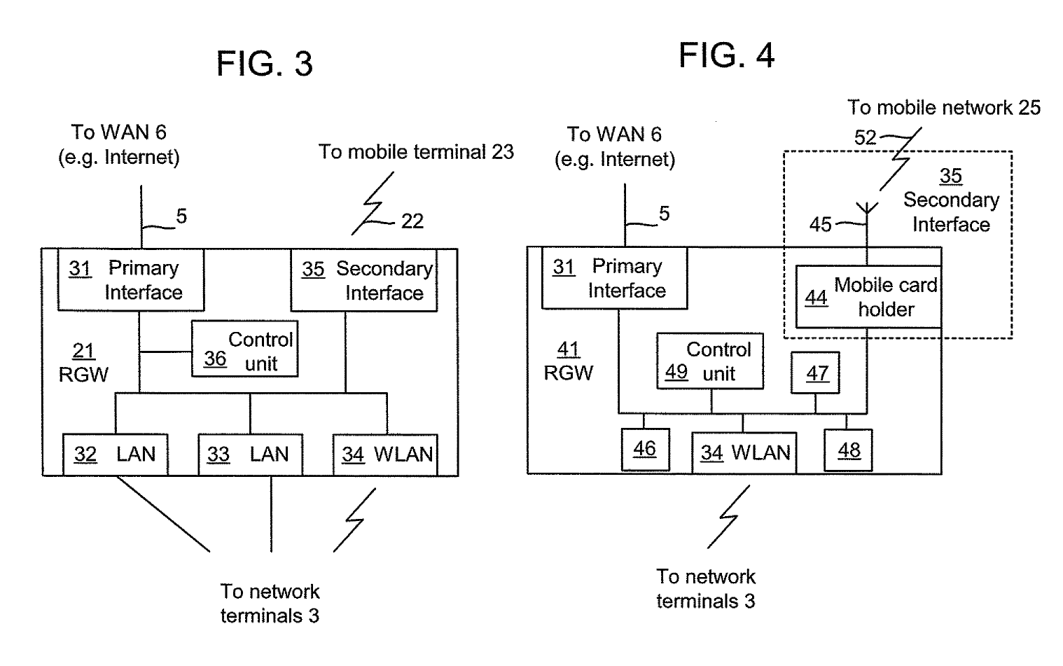

However, according to the inventive features of the invention, the residential gateway 21 is arranged with a secondary interface (shown in FIG. 3) such that the residential gateway 21 may establish a connection 22 with any available mobile terminal 23 located within access range of the secondary interface in the residential gateway 21. In this respect, a mobile terminal 23 may be said to be located within the residential network 2. The secondary interface is discussed in more detail in reference to FIG. 3 in the following.

By establishing the connection 22 with the mobile terminal 23, the residential gateway 21 may communicate with the mobile terminal 23 such that the mobile terminal 23 may establish a connection 24 with the mobile radio communications network 25; that is, the residential gateway 21 may use the available mobile terminal 23 as a modem.

Thus, the residential gateway 21 may provide a backup access path 26 to the external network 6 over the mobile radio communications network 25 when network connectivity is lost over the connection 5 comprising the normal access path 7. The backup access path 26 may be used by any number of network terminals 3 in the residential network 2. The backup access path 26 may also be used by the network terminals 3 in the residential network 2 without the need for any reconfigurations and/or new settings in the network terminals 3.

FIG. 3 shows residential gateway 21 according to an exemplary embodiment of the invention. The residential gateway 21 comprises a primary interface 31 for providing a connection 5 to an external network 6, such as, for example a WAN or the Internet. The primary interface 31 may comprise a xDSL or cable modem, or may be arranged to be connected to a external modem (not shown). The primary interface 31 may be connected to at least one network terminal interface 32, 33, 34 in the residential gateway 21. The at least one network terminal interface 32, 33, 34 may, for example, be an local area network (LAN) interface 32, 33 for physically connecting the residential gateway 21 to a network terminal 3, such as, for example, an Ethernet cable. The at least one network terminal interface 32, 33, 34 may also, for example, be a Wireless-LAN (WLAN) interface 34 for wirelessly connecting the residential gateway 21 to one or several network terminals 3.

The residential gateway 21 also comprises a secondary interface 35. The secondary interface 35 may also be connected to the at least one network terminal interface 32, 33, 34 in the residential gateway 21. The secondary interface 35 may, for example, comprise a Bluetooth interface, Universal Serial Bus [USB] interface, WiFi interface, or some other access technology interface which is capable of providing a connection 22 to a mobile terminal 23.

Furthermore, the residential gateway 21 comprises a control unit 36. The control unit 21 may be connected to the primary interface 31, the at least one network terminal interface 32, 33, 34 and the secondary interface 35. The control unit 36 comprises logic for performing the functionality of the residential gateway 21. This functionality may be implemented by means of a software or computer program. The control unit 36 may also comprise storage means or a memory unit for storing the computer program, and processing means or a processing unit, such as a microprocessor, for executing the computer program. When, in the above and in the following, it is described that the residential gateway 21 performs a certain function it is to be understood that the control unit 36 in the residential gateway 21 uses the processing means to execute a certain part of the program which is stored in the storage means.

The residential gateway 21 may be arranged to detect the status of the network connectivity over the primary interface 31. In response to detecting a loss of network connectivity through the primary interface 31 (which provides the normal access path 7 over the connection 5 in FIG. 2), the residential gateway 21 may be arranged to activate the secondary interface 35. Upon activation, the secondary interface 35 may establish the connection 22 between the residential gateway 21 and the mobile terminal 23.

If the secondary interface 35 comprises a Bluetooth interface, the connection 22 between the residential gateway 21 and the mobile terminal 23 may be established, as soon as the mobile terminal 23 has been made accessible to the Bluetooth interface in the secondary interface 35, by using features specified by the Bluetooth Dial-up Networking profile. The Bluetooth Dial-up Networking profile can be found in the Bluetooth specification, version 1.1, Part K:7 Dial-up Networking profile. This means that the mobile terminal 23 and Bluetooth interface have been paired. The mobile terminal 23 must also be within the range of the Bluetooth interface. The Bluetooth interface in the secondary interface 35 may be paired to more than one mobile terminal 23, which means that different mobile terminals 23 may be used for establishing the connection 22 at different points in time.

If the secondary interface 35 comprises a USB interface, the connection 22 between the residential gateway 21 and the mobile terminal 23 may be established as soon as the mobile terminal 23 has been connected to the USB interface via a USB cable. Although the connection 22 is shown in FIG. 2 as a wireless connection, it should be understood that the connection 22 may also be achieved using a physical connection, such as, for example, a USB cable.

By establishing the connection 22 with the mobile terminal 23 through the secondary interface 35, the residential gateway 21 may control the mobile terminal 23 such that the mobile terminal 23 may establish a connection 24 with a mobile radio communications network 25. That is, the residential gateway 21 may use the mobile terminal 23 as a modem. This may be performed using standard methods of controlling modems, such as, for example, the Hayes command set which is supported by almost all current mobile terminals 23. Thus, the residential gateway 21 is adapted to forward data traffic through the backup access path 26 created by said secondary interface 35 between the residential gateway 21 and the external network 6 (see FIG. 2).

FIG. 4 shows a residential gateway 41 according to another exemplary embodiment of the invention. The residential gateway 41 comprises a primary interface 31 for providing a connection 5 to an external network 6, such as, for example a WAN or the Internet. The primary interface 41 may comprise a xDSL or cable modem, or may be arranged to be connected to a external modem (not shown). The primary interface 31 may also be connected to at least one network terminal interface 34 in the residential gateway 41. The at least one network terminal interface may, for example, be a Wireless-LAN (WLAN) interface 34 for wirelessly connecting the residential gateway 41 to one or several network terminals 3. It should be understood that the residential gateway 41 may further comprise other network terminal interfaces, such as, for example, the local area network (LAN) interfaces 32, 33 shown in the exemplary embodiment in FIG. 3.

The residential gateway 41 may also comprise a secondary interface 35. The secondary interface 35 may be connected to the at least one network terminal interface 34 in the residential gateway 41. The secondary interface 35 may comprise mobile communications means arranged to connect to a mobile radio communications network 25. The mobile communication means may comprise a mobile terminal card holder 44 and a mobile radio transmitter 45. The mobile terminal card holder 44 may be arranged to receive a mobile terminal card, such as, a subscriber identity card (SIM), which provides the residential gateway 41 with a cellular service. The residential gateway 41 may use the mobile radio transmitter 45 of the secondary interface 35 in order to establish a connection with a mobile radio communications network 25 carrying the cellular service.

As in the previous embodiment described in FIG. 3, the residential gateway 41 comprises a control unit 49. The control unit 21 may be connected to the primary interface 31, the at least one network terminal interface 34 and the secondary interface 35. The control unit 49 comprises logic for performing the functionality of the residential gateway 41. This functionality may be implemented by means of a software or computer program. The control unit 49 may also comprise storage means or a memory unit for storing the computer program and processing means or a processing unit, such as a microprocessor, for executing the computer program. The storage means may also be readable storage medium separated from, but connected to the control unit 49. When, in the above and in the following, it is described that the residential gateway 41 performs a certain function it is to be understood that the control unit 49 in the residential gateway 41 uses the processing means to execute a certain part of the program which is stored in the storage means.

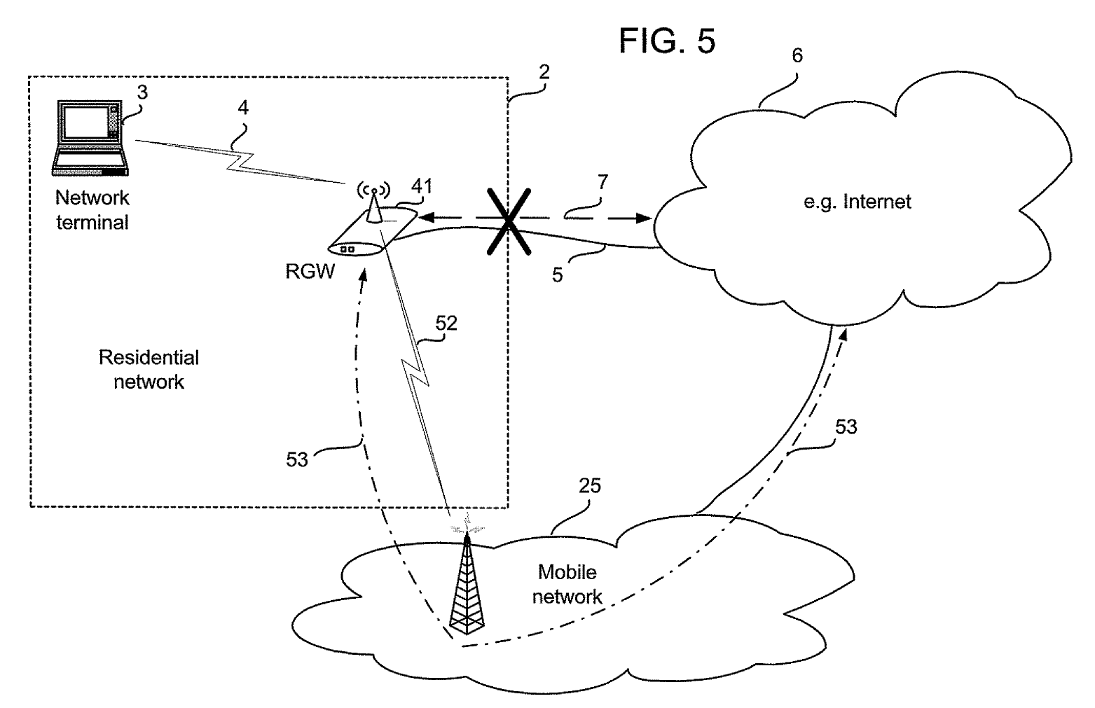

The residential gateway 41 may be arranged to detect the status of the network connectivity over the primary interface 31. In response to detecting a loss of network connectivity through the primary interface 31 (which provides the normal access path 7 over the connection 5 in FIG. 5), the residential gateway 41 may be arranged to activate the secondary interface 35. Upon activation, the residential gateway 41 may use the secondary interface 35 in order to establish the connection 52 between the residential gateway 41 and the mobile radio communications network 25. The residential gateway 41 may thus be arranged to forward data traffic through the backup access path 53, as shown in FIG. 5, between the residential gateway 21 and the external network 6 via the mobile radio communications network 25.

In order to achieve a suitable and user-friendly switch in the residential gateway 41, the residential gateway 41 may further comprise a first timing means 46, a second timing means 47 and an alerting means 48. The first timing means 46, the second timing means 47 and the alerting means 48 may be connected to the control unit 49 in the residential gateway 41, or may be implemented in directly inside the control unit 49, e.g. in the software or computer program. It should be noted that exemplary embodiment presented in FIG. 3 may also comprise the first timing means 46, the second timing means 47 and the alerting means 48.

The first timing means 46 may be, for example, a timer. The first timing means 46 may be started when the residential gateway 41 detects a loss of network connectivity through the primary interface 31. Upon the expiry of the first timing means 46, the residential gateway 41 may check if network connectivity through the primary interface 31 may be reestablished. If so, the residential gateway 46 may be arranged to begin re-establishing network connectivity over the connection 5 through the primary interface 31. If not, the first timing means 46 may be reset and restarted. The first timing means 46 provides the residential gateway 41 with the advantage of being able to repeatedly test the network connectivity status over the connection 5 through the primary interface 31.

The second timing means 47 may also be, for example, a timer. The second timing means 47 may be started when the residential gateway 41 detects that network connectivity through the primary interface 31 may be re-established. Upon the expiry of the second timing means 47, the residential gateway 41 may be arranged to begin re-establish network connectivity over the connection 5 through the primary interface 31, resume to forward data traffic over the normal access path 7 provided by the connection 5, and deactivate the secondary interface 35. The second timing means 47 provides the residential gateway 41 with the advantage of waiting a predetermined period of time before starting to re-establish the network connectivity over the connection 5 through the primary interface 31. This may be beneficial for an end user of a network terminal 3 since it may allow the end user to, for example, end a currently on-going communication over the external network 6 before switching back to the normal access path 7.

The alerting means 48 may be, for example, an alarm or some other indicator capable of attracting the attention from of end user of a network terminal 3 in the residential network 2. The alerting means 48 may be used by the residential gateway 41 in order to alert an end user of a network terminal 3 in the residential network 2 of the fact that network connectivity over the connection 5 through the primary interface 31 is lost. It may also alert an end user of the fact that the residential gateway 41 has activated the second interface 35. Furthermore, the alerting means 48 may be used by the residential gateway 41 in order to alert an end user of the fact that network connectivity over the connection 5 through the primary interface 31 may be re-established. The alerting means 48 provides the residential gateway 41 with the advantage of being able to notify the end user of events occurring in the residential gateway 41.

FIG. 5 shows a residential gateway 41 according to the exemplary embodiment of the invention shown in FIG. 4 connecting a residential network 2 to an external network 6 by providing a backup access path 53 over a mobile radio communications network 25.

In FIG. 5, a residential gateway 41 is connected to a residential network 2. The residential network 2 may comprise at least one network terminal 3. The residential gateway 41 is arranged to communicate with the at least one network terminal 3 over a connection 4. The residential gateway 41 may thus provide a normal access path 7 to the external network 6 for the network terminals 3 in the residential network 2 over the connection 5.

However, as in FIG. 2 and as illustrated by the large “X” in FIG. 5, the network connectivity over the connection 5 providing the normal access path 7 to the external network 6 may, for example, be temporarily lost. The residential gateway 41 may thus establish a direct connection 52 with a mobile radio communications network 25. By establishing the direct connection 52 with the mobile radio communications network 25, the residential gateway 41 may enable a backup access path 53 to the external network 6 for the network terminals 3 in the residential network 2 over the mobile radio communications network 25.

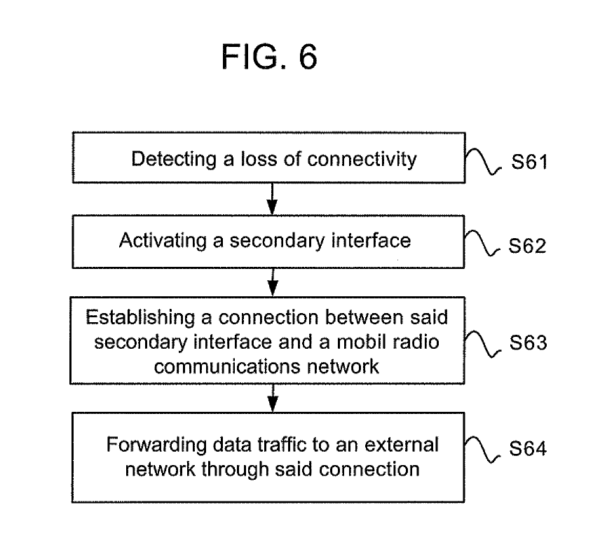

FIG. 6 is a flowchart illustrating a method in a residential gateway 21, 41 for providing a residential network 2 with network access according to an exemplary embodiment of the invention.

In step S61, the residential gateway 21, 41 may detect as the network connectivity over the connection 5 to the external network 6 is lost. In step S62, the residential gateway 21, 41 may activate a secondary interface 35 located in the residential gateway 21, 41 in response to the detection in step S61.

In step S63, the residential gateway 21, 41 may establish a connection 22, 24, 52 between the activated secondary interface 35 in said residential gateway 21, 41 and a mobile radio communications network 25. This may be performed in order to provide a backup access path 26, 53 to the external network 6.

If the activated secondary interface 35 in the residential gateway 21, 41 comprises mobile communication means 44, 45, the residential gateway 21, 41 may establish a direct connection between the secondary interface 35 and the mobile radio communications network 25. If the residential gateway 21, 41 comprises an access technology interface which is capable of providing a connection 22 to a mobile terminal 23, the residential gateway 21, 41 may first establish a connection 22 to the mobile terminal 23 and then control the mobile terminal 24 so as to establish another connection 24 to the mobile radio communications network 25.

In step S64, the residential gateway 21, 41 may start to forward data traffic between the residential network 2 and the external network 6 over the mobile radio communications network 25. This may be performed through the connection 22, 24, 52 between the activated secondary interface 35 and the mobile radio communications network 25 providing the backup access path 26, 53.

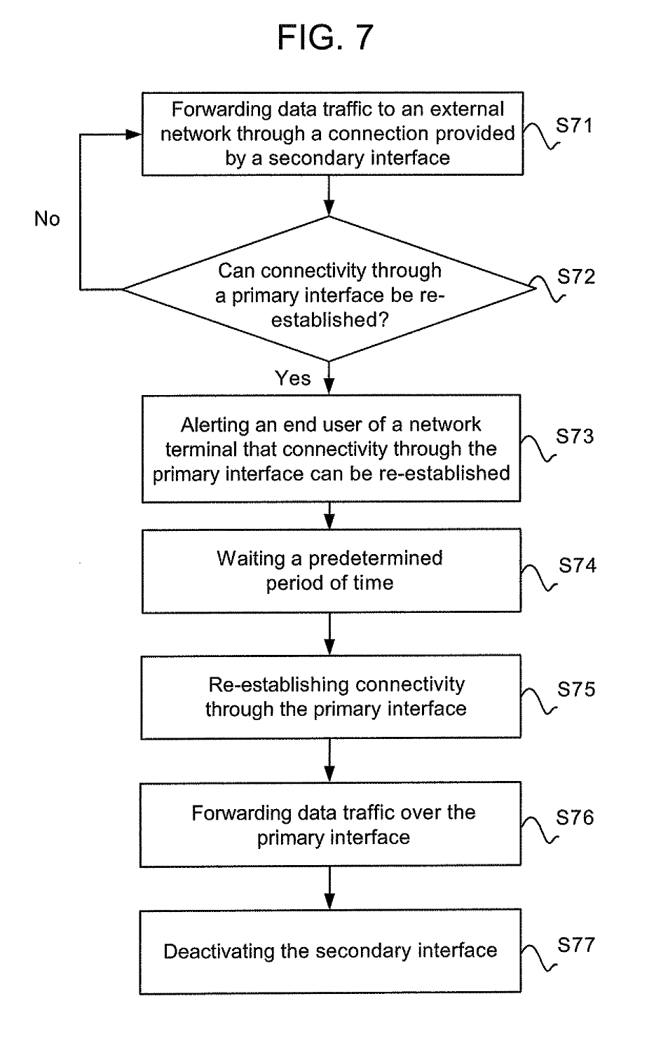

FIG. 7 is a flowchart illustrating a method in a residential gateway 21, 41 for providing a residential network 2 with network access according to another exemplary embodiment of the invention.

In step S71, the residential gateway 21, 41 is forwarding data traffic to an external network 6 through a connection 22, 24, 52 provided by a secondary interface 35. The connection 22, 24, 52 provided by the secondary interface 35 may have been established according to the exemplary embodiment described in FIG. 6.

In step S72, a first timing means 46 in the residential gateway 21, 41 may expire, whereby the residential gateway 21, 41 may check if network connectivity through the primary interface 31 can be re-established. If no, the first timing means 46 may be reset and restarted, and the residential gateway 21, 41 may return to step S71. If yes, the residential gateway 21, 41 may perform step S73.

In step S73, the residential gateway 21, 41 may alert an end user of a network terminal 3 that network connectivity through the primary interface 31 can be re-established. This may be performed by using the alerting means 48. In step S74, the residential gateway 21, 41 may wait a predetermined period of time. This may be performed by using the second timing means 47, and in order to allow an end user to, for example, end a currently on-going communication over the external network 6 before the residential gateway 21, 41 switches back to the connection 5 over the primary interface 31.

In step S75, the residential gateway 21, 41 may establish network connectivity over the connection 5 through the primary interface 31. In step S76, the residential gateway 21, 41 may switch from forwarding data traffic over the secondary interface 35 to forwarding data traffic over the primary interface 31. In step S77, the residential gateway 21, 41 may deactivate the secondary interface 31.

It should also be noted that although the residential gateway 21, 41 is described above as activating the secondary interface 35 only when the network connectivity over the connection 5 to the external network 6 is lost, the residential gateway 21, 41 may be arranged to activate said secondary interface 35 at any moment in time, for example, as soon as it is powered on. For example, the residential gateway 41 according to the exemplary embodiment of the invention shown in FIG. 4, may be arranged to register the residential gateway 41 with a cellular service associated with the mobile terminal card as soon as the residential gateway 41 is powered on. It may in this way already have the secondary interface 35 activated, should the network connectivity over the connection 5 to the external network 6 be lost.

It is also easy to imagine several more instances where the secondary interface 35 of the residential gateway 21, 41 may be activated before the network connectivity is lost, for example, if the secondary interface 35 has been activated and/or used a large number of times over a certain time period, the residential gateway 21, 41 may decide to keep it activated for a predetermined period of time in future. The residential gateway 21, 41 may then de-active the secondary interface 35 if it has not been used again or frequently during the predetermined period of time.

The description above is of the best mode presently contemplated for practising the invention. The description is not intended to be taken in a limiting sense, but is made merely for the purpose of describing the general principles of the invention. The scope of the invention should only be ascertained with reference to the issued claims.

1-11. (canceled)

12. A residential gateway for providing an end user of a network terminal in a residential network with access to an external network, said residential gateway comprising:
at least one network terminal interface arranged to provide an internal connection to said network terminal and a primary external network interface arranged to provide a first external connection to said external network,
a secondary external network interface arranged to establish a second external connection with a mobile radio communications network in order to provide a backup access path to said external network; and,
a control unit arranged to activate said secondary external network interface, if not already activated, in response to detecting a loss of network connectivity over said first external connection, and forward data traffic between said residential network and said external network through said activated secondary external network interface, wherein said second external connection comprises a third external connection between said secondary external network interface and a mobile terminal, and a fourth external connection between said mobile terminal and said mobile radio communications network, and said residential gateway is further arranged to establish said fourth external connection by using said mobile terminal as a modem.

13. A residential gateway according to claim 12, wherein said secondary external network interface comprises a Bluetooth interface, Universal Serial Bus interface, WiFi interface, or some other access technology interface capable of providing said third external connection to a mobile terminal.

14. A residential gateway according to claim 12, further comprising a first timing means upon the expiry of which the control unit in said residential gateway checks if network connectivity over said first external connection can be re-established.

15. A residential gateway according to claim 12, further comprising a second timing means upon the expiry of which the control unit in said residential gateway is arranged to re-establish network connectivity over said first external connection, resume to forward data traffic over said first external connection, and deactivate the secondary external network interface.

16. A residential gateway according to claim 12, further comprising alerting means arranged to be used by the control unit in order to alert and attract the attention of an end user of a network terminal in the residential network.

17. A method for use in a residential gateway in order to provide an end user of a network terminal in said residential network with access to an external network, said residential gateway comprising at least one network terminal interface arranged to provide an internal connection to said network terminal and a primary external network interface arranged to provide a first external connection to said external network, the method comprising the steps of:
detecting in said residential gateway whether network connectivity over said first external connection is lost;
activating a secondary external network interface, if not already activated, in said residential gateway in response to said detection;
establishing a secondary external connection between said activated secondary external network interface in said residential gateway and a mobile radio communications network in order to provide a backup access path to said external network;
forwarding data traffic between said residential network and said external network through said backup access path, wherein said secondary external connection comprises a third external connection between said secondary external network interface and a mobile terminal, and a fourth external connection between said mobile terminal and said mobile radio communications network; and,
establishing said fourth external connection by using said mobile terminal as a modem.

18. A method according to claim 17, further comprising the steps of:
checking at predetermined time intervals if network connectivity over said first external connection can be re-established and, if so, re-establishing network connectivity over said first external connection and forwarding data traffic over said first external connection; and,
deactivating said secondary external connection over said secondary external network interface in response to data traffic being forwarded over said first external connection.

19. A method according to claim 18, further comprising the steps of:
if network connectivity over said first external connection can be re-established, alerting an end user of a network terminal in the residential network that network connectivity over said first external connection can be re-established; and,
waiting a predetermined period of time before re-establishing said network connectivity and forwarding data traffic over said first external connection and before deactivating said secondary external connection over said secondary external network interface.
